(19) United States
(12) Patent Application Publication
(10) Pub. No.: US 2015/0304271 A1
(43) Pub. Date: Oct. 22, 2015

(54) Address resolution protocol buffer and buffering method thereof

(71) Applicant: ZTE CORPORATION, Shenzhen, Guangdong (CN)

(72) Inventor: Yongjun Ma, Shenzhen (CN)

(21) Appl. No.: 14/647,572

(22) PCT Filed: Oct. 29, 2013
(86) PCT No.: PCT/CN2013/086176

§ 371 Date: May 27, 2015

(30) Foreign Application Priority Data
Nov. 28, 2012 (CN) 201210494749.7

(51) Int. Cl. H04L 29/12; H04L 12/841; H04L 29/08

(52) U.S. Cl. CPC H04L 61/103; H04L 67/2842; H04L 61/6022; H04L 61/2007; H04L 47/28; H04L 67/1095

(57) ABSTRACT

An Address Resolution Protocol, ARP, cache is provided, including a network interface module, configured to send an Internet Protocol, IP, data package to the searching module for IP address searching; and to send an acquired Media Access Control, MAC, address to the searching module after the IP address searching fails; a searching module, configured to search, according to the IP data package sent from the network interface module, the ARP cache module for the IP address; and to store the IP address and the MAC address sent from the network interface module in the ARP cache module after the IP address searching fails; and the ARP cache module, configured to provide the IP address to the searching module for the IP address searching; to store the IP address in the ARP cache module after the IP address searching fails.

### TECHNICAL FIELD

The present disclosure relates to the field of Address Resolution Protocol (ARP) cache on Internet, and in particular to an ARP cache and associated ARP caching method.

### BACKGROUND

ARP is a protocol used for determining the physical address of a host in the case that only the Internet Protocol (IP) address of the host is known. The IP address may be mapped to the physical address in two approaches: table approach and non-table approach. Specifically, the ARP parses an address on the network layer to a physical address on the data link layer, i.e., parses an IP address to a Media Access Control (MAC) address.

Generally, amongst a number of network protocols and applications, a sender has more than one IP data package to be sent to a same destination. If each of the data packages sent to the same host or router uses ARP, it leads to low efficiency. This problem may be solved by employing an ARP cache table. Generally, after a host or a router acquires a correspondence between the IP address and the physical address of a certain far-end using ARP, it stores this correspondence in a local ARP cache table, so as to facilitate use of following IP data packages to be sent to the same destination. Thus, there is an ARP cache table in each host or router in which the Transmission Control Protocol/Internet Protocol (TCP/IP) is installed. When it is required to send an IP data package on the network layer, this ARP cache table is searched for the physical address of the destination host or router to which the IP data package is sent; when the searching fails, the execution of ARP is triggered, and the physical address of the destination host or router is acquired dynamically using ARP and stored in the ARP cache table. The use of an ARP cache table improves the efficiency of the data transmission and saves the network traffic.

Generally, the ARP cache table does not store items therein for a long time. The reason is that, firstly, there are limited resources for the ARP cache table, and secondly, a Timeout processing has to be performed on the ARP cache table to avoid illegal attacks such as ARP deception. The process for performing the Timeout processing on a table item in an ARP cache table is called ARP aging. For a system evolved from the Berkeley system, the time limit for a complete table item is set to 20 minutes in general, while the time limit for an incomplete table item is set to 3 minutes, and the time limit for an table item which is used again is reset to 20 minutes. Whereas, after the ARP cache table is filled up, and before any of the ARP table items reaches the aging time, the system is not capable of communicating with other hosts out of the ARP cache table.

### SUMMARY

On this account, the embodiments of the present disclosure provides an ARP cache and corresponding ARP caching method, allowing communication with other hosts out of the ARP cache table, after the ARP cache table is filled up and before any of the ARP table items reaches the aging time.

An embodiment of the present disclosure provides an ARP cache which comprises a network interface module, a searching module and an ARP cache module;

wherein the network interface module is configured to send an IP data package to the searching module for IP address searching; and to send an acquired MAC address corresponding to the IP address to the searching module after the IP address searching fails;

wherein the searching module is configured to search, according to the IP data package sent from the network interface module, the ARP cache module for the IP address corresponding to the IP data package; and to store the IP address and the MAC address sent from the network interface module corresponding to the IP address in the ARP cache module after the IP address searching fails; and

wherein the ARP cache module is configured to provide the IP address to the searching module for the IP address searching; to store the IP address and the MAC address corresponding to the IP address after the IP address searching fails.

In the schema described above, the network interface module is further configured to acquire the MAC address corresponding to the IP address after the IP address is stored in the ARP cache module.

In the schema described above, the ARP cache module is further configured to: when there is a local table item in an FREE state, store the IP address in the table item directly; and when there is no local table item in the FREE state, empty a table item with a minimum time field and store the IP address in the table item with the minimum time field.

In the schema described above, the network interface module is further configured to receive the IP data package including the MAC address from the ARP cache module after the IP address searching succeeds;

the searching module is further configured to store the received IP data package in the ARP cache module after the IP address searching succeeds; and

the ARP cache module is further configured to, after the IP address searching succeeds, copy the MAC address corresponding to the IP address into a head of the IP data package and send the IP data package including the MAC address to the network interface module.

In the schema described above, the ARP cache module is further configured to store the MAC address corresponding to the IP address after the IP address searching fails, and to store the IP data package after the IP address searching succeeds.

In the schema described above, the ARP cache further comprises a time synchronization module configured to provide the ARP cache module with current synchronized time.

In the schema described above, the ARP cache module comprises an IP address storage unit, a MAC address storage unit, a state storage unit, an IP data package storage unit and a time storage unit;

wherein the IP address storage unit is configured to provide the IP address to the searching module for the IP address searching, and to store the IP address after the IP address searching fails;

wherein the MAC address storage unit is configured to store the MAC address corresponding to the IP address, to copy the MAC address into the head of the IP data package and to send the IP data package including the MAC address to the network interface module;

wherein the state storage unit is configured to store the state of the table item;

wherein the IP data package storage unit is configured to store the IP data package; and

wherein the time storage unit is configured to store time at which the IP address is stored, and to update the time with current time when the MAC address is being used.

An embodiment of the present disclosure provides a ARP caching method, which comprises:

sending a current IP data package to an APR cache for IP address searching;

storing the IP address in the ARP cache and storing a received MAC address corresponding to the IP address in the ARP cache after the IP address searching fails.

In the schema described above, after the storing the IP address in the ARP cache, the method further comprises acquiring the MAC address corresponding to the IP address.

In the schema described above, the storing the IP address in the ARP cache comprises:

when the ARP cache has a table item in an FREE state, storing the IP address in the table item directly; and

when the ARP cache has no table item in the FREE state, emptying a table item with a minimum time field and storing the IP address in the table item with the minimum time field.

In the schema described above, the method further comprises: after the IP address searching succeeds, copying the MAC address corresponding to the IP address into a head of the IP data package and sending the IP data package including the MAC address to a destination terminal.

In the schema described above, after the storing the IP address in the ARP cache, the method further comprises acquiring the MAC address corresponding to the IP address.

In the schema described above, the acquiring the MAC address corresponding to the IP address comprises:

broadcasting an ARP request message containing an destination IP address on the network layer;

returning, by an IP terminal with the destination IP address, an ARP response message containing the MAC address corresponding to the IP address to the ARP cache;

receiving, by the ARP cache, the ARP response message and acquiring the MAC address corresponding to the IP address according to the ARP response message.

In comparison to the prior art, according to the ARP cache and associated ARP caching method provided in the embodiments of the present disclosure, after the ARP cache is filled up, an ARP cache module empties a table item with a minimum time field and sets the state field of that table item in an FREE state. In this way, a new destination IP address may be stored in that table item immediately. Further, an MAC address corresponding to the stored new IP address is acquired and stored in that table item. In this way, an IP data package may be sent to the destination IP terminal by employing the new MAC address stored in that ARP cache.

### BRIEF DESCRIPTION OF THE DRAWINGS

FIG. 1 is a block diagram of an ARP cache according to an embodiment of the present disclosure;

FIG. 2 is a flow chart of the ARP caching method implemented by the ARP cache according to a first embodiment of the present disclosure;

FIG. 3 is a flow chart of the ARP caching method implemented by the ARP cache according to a second embodiment of the present disclosure; and

FIG. 4 is a view of the state transition of the ARP cache according to an embodiment of the present disclosure.

### DETAILED DESCRIPTION

The embodiments of the present disclosure are described in further detail in combination with the drawings, which are merely used for illustration but not to limit the embodiments of the present disclosure, so that the features and technical content of the embodiments of the present disclosure may be understood better.

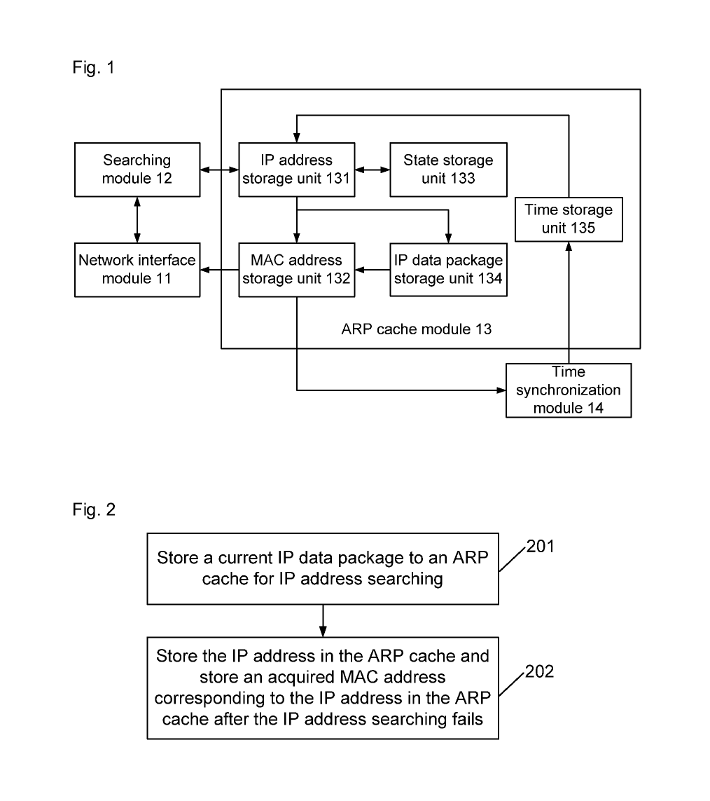

FIG. 1 is a block diagram of an ARP cache according to an embodiment of the present disclosure. As shown in FIG. 1, the ARP cache comprises: a network interface module 11, a searching module 12 and an ARP cache module 13.

The network interface module 11 is configured to send an IP data package to the searching module 12 for IP address searching; and to send an acquired MAC address corresponding to the IP address to the searching module 12 after the IP address searching fails.

Here, the IP data package is a set of data sent from a local terminal to a destination MAC address, including: a destination IP address, a source IP address and a source MAC address, etc.

The network interface module 11 is further configured to acquire the MAC address corresponding to the IP address after the IP address is stored in the ARP cache module 13.

Preferably, the network interface module 11 is further configured to receive the IP data package including the MAC address from the ARP cache module 13 after the IP address searching succeeds.

Preferably, the network interface module 11 is further configured to receive an IP address searching failure information sent from the searching module 12 after the IP address searching fails.

Preferably, the network interface module 11 is further configured to acquire the MAC address after the IP address searching fails.

Specifically, after the IP address searching fails, the network module 11 broadcasts an ARP request message containing a destination IP address on the network layer; the IP terminal with that destination IP address returns an ARP response message containing an MAC address corresponding to the destination IP address to the network interface module 11; the network interface module 11 receives this ARP response message, and therefore the network interface module 11 acquires the MAC address from the ARP response message.

The searching module 12 is configured to receive the IP data package sent from the network interface module 11, to search the ARP cache module for the IP address corresponding to the IP data package according to this IP data package; and to store the IP address and the MAC address sent from the network interface module 11 corresponding to the IP address in the ARP cache module after the IP address searching fails.

Here, the IP address for which the ARP cache module 13 is searched is the destination IP address of the received IP data package; accordingly, the failure in IP address searching means that the destination IP address of the received IP data package has not been found in the ARP cache module 13.

Preferably, the searching module 12 is further configured to send an IP address searching failure information to the network interface module 11;

the ARP cache module 13 is configured to provide the IP address to the searching module 12 for searching; to store the IP address and the MAC address corresponding to the IP address after the IP address searching fails;

the ARP cache module 13 is further configured to: when there is a local table item in an FREE state, store the IP address in the table item directly; and when there is no local table item in the FREE state, empty a table item with a minimum time field and store the IP address in the table item with the minimum time field.

Here, the storage of the IP address in the ARP cache module 13 may include the following:

when the ARP cache module 13 has an table item in an FREE state, the IP address is stored in this table item directly and the state field is set in a PENDING state; or

when the ARP cache module 13 has no table item in the FREE state, a table item with a minimum time field is emptied and its state field is set as FREE, the IP address is stored in this table item and the state field is set in the PENDING state;

preferably, the table items in which time fields have a difference with respect to current time more than a value Timeout are all emptied and their state fields are set as FREE;

here, said table item is a set of date recording the mapping from the IP address to the MAC address, including: an IP address, a MAC address, a state field, a time field, a queue number field and the like, in which

the IP address is used for recording an IP address;

the MAC address is used for recording a MAC address corresponding to said IP address;

the state field is used for recording the recording status of the IP address and the MAC address;

the time field is used for recording the time when the IP address is recorded and updating this time with the time when the MAC address is used;

the queue number field is used for recording the IP data packages stored behind the IP address;

preferably, the state field includes: FREE state, PENDING state or RESOLVED state;

where the FREE state corresponds to the case in which neither IP address nor MAC address is recorded; the PENDING state corresponds to the case in which IP address is recorded and MAC address is not recorded; and the RESOLVED state corresponds to the case in which both IP address and MAC address are recorded;

accordingly, the FREE state indicates that the table item may be used by other new IP addresses; the PENDING state indicates that the table item is waiting for the MAC address to be recorded; and the RESOLVED state indicates that the MAC address in the table item is available;

here, the time field specifically indicates that, when a new IP address is stored in a table item in the FREE state, the current synchronization time is stored in the time field of this table item; when the MAC address corresponding to the IP address of this table item is used, the stored time field is updated with the current synchronization time at which the MAC address corresponding to the IP address of this table item is used;

accordingly, the table item with a minimum time field is a time field which has been stored earliest;

here, the Timeout is a preset Timeout which is generally between 2 and 4 minutes;

the ARP cache module 13 is further configured to, after the IP address searching succeeds, copy the MAC address corresponding to this IP address into a head of the IP data package and send the IP data package including the MAC address to the network interface module 11.

Here, the storing the MAC address in the ARP cache module 13 may include:

storing the MAC address in a table item including the IP address corresponding to the MAC address; setting the original PENDING state as the RESOLVED state after the MAC address is stored;

preferably, the searching module 12 is further configured to store the received IP data package in the ARP cache module 13 after the IP address searching succeeds;

here, the storing the IP data package in the ARP cache module 13 may include: storing the IP data package in a table item including the IP address corresponding to the IP data package; specifically behind the queue number in the table item; preferably, all of the IP data packages for the same IP address are stored behind this queue number in sequence;

preferably, after the IP address is stored, the ARP cache module 13 is further configured to store the MAC address corresponding to this IP address;

preferably, the ARP cache module 13 is further configured to store the IP data package after the IP address searching succeeds;

here, the table item for storing the IP data package includes two states: a RESOLVED state and a PENDING state;

preferably, when the table item is in the RESOLVED state, i.e., the table item has stored the MAC address, the MAC address is copied into the head of the IP data package behind the queue number and sent to the network interface module 11; when the table item is in the PENDING state, i.e., the table item has not stored any MAC address, the IP data package behind the queue number is in a ready-to-send state, and no MAC address is copied into the head of the IP data package behind the queue number and sent to the network interface module 11 till this table item stores the MAC address and turns into the RESOLVED state;

accordingly, the network interface module 11 receives the IP data package which contains the MAC address and then sends it to the destination IP terminal according to the MAC address, i.e., the destination MAC address.

Preferably, this ARP cache further includes a time synchronization module 14 configured to provide current synchronization time to the ARP cache module 13;

specifically, the time synchronization module 14 provides current synchronization time in the following way: when a new IP is stored in a table item in the FREE state, the current synchronization time is stored in the time field of this table item; when the MAC address corresponding to the IP address of this table item is used, the stored time field is updated with the current synchronization time at which the MAC address corresponding to the IP address of this table item is used.

Preferably, the ARP cache module 13 includes an IP address storage unit 131, a MAC address storage unit 132, a state storage unit 133, an IP data package storage unit 134 and a time storage unit 135, in which

the IP address storage unit 131 corresponds to an IP address portion in the table item, which is used for providing the IP address to the searching module 12 for IP address searching; and storing the searched IP address after the IP address searching fails;

here, the IP address storage unit 131 stores the IP address in the following ways:

when the ARP cache module 13 has a table item in the FREE state, the IP address is stored in the IP address storage unit 131 directly and the state field is set as the PENDING state;

when the ARP cache module 13 has no table item in the FREE state, a table item with a minimum time field is emptied and its state field is set as FREE, and the IP address is stored in the IP address storage unit 131 in this table item and the state field is set as the PENDING state; preferably, the table items in which time fields have a difference with respect to current time more than a Timeout are all emptied and their state fields are set as FREE;

the MAC address storage unit 132 corresponds to an MAC address portion in the table item, which is used for storing the MAC address corresponding to the IP address, and for copying the MAC address into the head of the IP data package and sending the IP data package including the MAC address to the network interface module 11;

here, the storing the MAC address corresponding to the IP address specifically includes: storing the MAC address in the MAC address storage unit 132 in the table item which stores the corresponding IP address; and setting the original PENDING state as the RESOLVED state;

the state storage unit 133 corresponds to a state field in the table item configured to store the state of the table item;

specifically, the state of the state storage unit 133 includes: FREE, PENDING, RESOLVED;

the FREE state indicates that the IP address storage unit 131 and the MAC address storage unit 132 is in the FREE state and may be used for other new IP addresses and MAC addresses;

the PENDING state indicates that the IP address storage unit 131 in the table item stores an IP address, while the MAC address storage unit 132 does not store any MAC address, and is in a state of ready-to-receive MAC address;

the RESOLVED state indicates that the IP address storage unit 131 and the MAC address storage unit 132 store an IP address and an MAC address respectively, the IP data package being capable of transmitting data using this MAC address;

the IP data package storage unit 134 corresponds to the queue number field in the table item configured to store the IP data package;

here, the storing the IP data package specifically includes: storing the IP data package in the IP data package unit 134 of the table item which stores the corresponding IP address; preferably, all of the IP data packages for the same IP address are stored behind this IP data package storage unit 134 in sequence;

accordingly, the MAC address storage unit 132 stores the MAC address in the head of the IP data package specifically as follows: when the state storage unit 133 is in the RESOLVED state, i.e., the table item has stored the MAC address, the MAC address is copied into the head of the IP data package in the IP data package storage unit 134 and sent to the network interface module 11; when the state storage unit 133 stores the PENDING state, i.e., the table item has not stored any MAC address, the IP data package in the IP data package storage unit 134 is in the ready-to-send state, and no MAC address is copied into the head of the IP data package in the IP data package storage unit 134 and sent to the network interface module 11 till the MAC address storage unit 132 stores the MAC address and further the state storage unit 133 stores the RESOLVED state;

the time storage unit 135 corresponds to a time field in the table item configured to store the time when the IP address is stored, and to update the time with current time when the MAC address is used;

the use of the MAC address refers to that the MAC address storage unit 132 copied the MAC address into the head of the IP data package.

In specific implementation, the network interface module 11 in the ARP cache described above may be implemented with an Ethernet controller; the searching module 12 may be implemented with a Central Processing Unit (CPU), a Digital Signal Processor (DSP) or a Field Programmable-Gate Array (FPGA). The ARP cache module 13 may be implemented as a cache.

FIG. 2 is a flow chart of the ARP caching method implemented by the ARP cache according to a embodiment of the present disclosure. As shown in FIG. 2, the method includes the steps as follows:

Step 201: send a current IP data package to an ARP cache for IP address searching;

here, the IP data package is a set of data sent from a local terminal to a destination MAC address, which includes: a destination IP address, a source IP address, a source MAC address, etc.;

the IP address searching is to search for the destination IP address of the IP data package.

Step 202: store this IP address in the ARP cache and store a received MAC address corresponding to this IP address in the ARP cache after the IP address searching fails;

here, this IP address is the destination IP address of the IP data package;

the IP address may be stored in the ARP cache in the following ways:

when the ARP cache has a table item in the FREE state, the IP address is stored in this table item directly and the state field is set as the PENDING state;

when the ARP cache has no table item in the FREE state, a table item with a minimum time field is emptied and its state field is set as FREE, the IP address is stored in this table item and the state field is set in the PENDING state;

preferably, the table items in which time fields have a difference with respect to current time more than a Timeout are all emptied and their state fields are set as FREE;

here, said table item is a set of date recording the mapping from the IP address to the MAC address, including: an IP address, a MAC address, a state field, a time field, a queue number field and the like, in which

the IP address is used for recording an IP address;

the MAC address is used for recording a MAC address corresponding to said IP address;

the state field is used for recording the recording status of the IP address and the MAC address;

the time field is used for recording the time when the IP address is recorded and updating this time with the time when the MAC address is used;

the queue number field is used for recording the IP data packages stored behind the IP address;

preferably, the content of the state field includes: FREE state, PENDING state, RESOLVED state;

where the FREE state corresponds to the case in which neither IP address nor MAC address is recorded; the PENDING state corresponds to the case in which IP address is recorded but MAC address is not recorded; and the RESOLVED state corresponds to the case in which both IP address and MAC address are recorded;

accordingly, the FREE state indicates that the table item may be used by other new IP addresses; the PENDING state indicates that the table item waits for recording the MAC address; and the RESOLVED state indicates that the MAC address in the table item is available;

here, the time field specifically indicates that, when a new IP is stored in a table item in the FREE state, the current synchronization time is stored in the time field of this table item; when the MAC address corresponding to the IP address of this table item is used, the stored time field is updated with the current synchronization time at which the MAC address is used;

accordingly, the table item with a minimum time field is a time field which has been stored earliest;

here, the Timeout is a preset Timeout which is generally between 2 and 4 minutes.

Preferably, after the IP address is stored in the ARP cache, the method further comprises acquiring the MAC address corresponding to the IP address;

specifically, the ARP cache broadcasts an ARP request message containing a destination IP address on the network layer; accordingly, the IP terminal with that destination IP address returns an ARP response message containing an MAC address corresponding to the destination IP address to the ARP cache; the ARP cache receives this ARP response message, and therefore the ARP cache acquires the MAC address from the ARP response message.

The method further includes: the ARP cache sends the IP data package to the destination IP terminal according to the MAC address corresponding to the IP address;

here, the IP address is the destination IP address; accordingly, the MAC address corresponding to the destination IP address, i.e., the destination MAC address, is copied into the head of the IP data package behind the queue number, and the IP data package is sent to the destination IP terminal according to this MAC address.

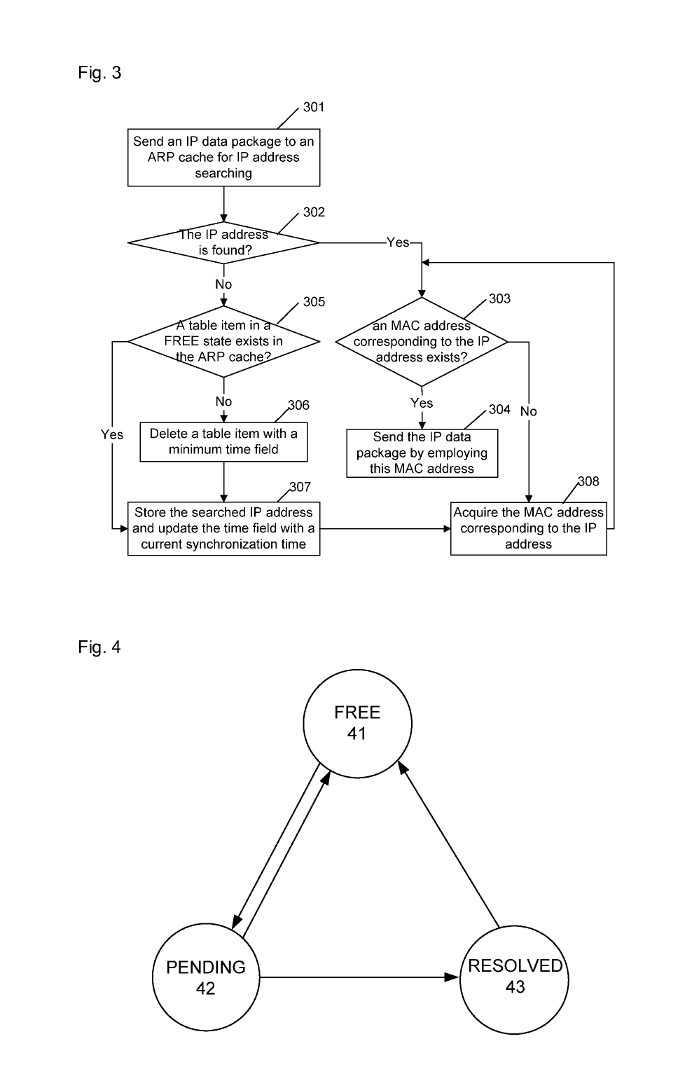

FIG. 3 is a flow chart of the ARP caching method implemented by the ARP cache according to an embodiment of the present disclosure. As shown in FIG. 3, the method includes the steps as follows:

Step 301: send a current IP data package to an ARP cache for IP address searching;

here, the IP data package is a set of data sent from a local terminal to a destination MAC address, which includes: a destination IP address, a source IP address, a source MAC address, etc.;

the IP address searching is to search for the destination IP address of the IP data package.

Step 302: determine whether the IP address is found, then execute Step 303 if the IP address is found, which means that the IP address searching succeeds; and execute Step 305 if the address is not found, which means that the IP address searching fails;

here, the IP address is the destination IP address of the IP data package.

Step 303: determine whether the ARP cache has a MAC address corresponding to the IP address, then execute Step 304 if the MAC address exists; otherwise execute Step 308;

there may be a step of storing the IP data package in the ARP cache before Step 303. Specifically, the IP data package is stored in the table item with the IP address corresponding to the IP data package;

preferably, the IP data package is stored behind the queue number in the table item, which means that all of the IP data packages for the same IP address are stored behind this queue number in sequence.

Step 304: send the IP data package according to the MAC address and terminate the current process;

specifically, the MAC address, i.e., the destination MAC address, is copied into the head of the IP data package behind the queue number, and the IP data package is sent to the destination IP terminal according to this MAC address.

Step 305: determine whether the ARP cache has a table item in the FREE state, then execute Step 306 if there is no table item in the FREE state; otherwise, execute Step 307 directly;

here, said table item is a set of date recording the mapping from the IP address to the MAC address, including: an IP address, a MAC address, a state field, a time field, a queue number field and the like, in which

the IP address is used for recording an IP address;

the MAC address is used for recording a MAC address corresponding to said IP address;

the state field is used for recording the recording status of the IP address and the MAC address;

the time field is used for recording the time when the IP address is recorded and updating this time with the time when the MAC address is used;

the queue number field is used for recording the IP data packages stored behind the IP address;

preferably, the state field includes: FREE state, PENDING state, RESOLVED state;

where the FREE state corresponds to the case in which neither IP address nor MAC address is recorded; the PENDING state corresponds to the case in which IP address is recorded but MAC address is not recorded; and the RESOLVED state corresponds to the case in which both IP address and MAC address are recorded;

accordingly, the FREE state indicates that the table item may be used by other new IP addresses; the PENDING state indicates that the table item waits for the MAC address to be recorded; and the RESOLVED state indicates that the MAC address in the table item is available;

here, the time field specifically indicates that, when a new IP is stored in a table item in the FREE state, the current synchronization time is stored in the time field of this table item; when the MAC address corresponding to the IP address of this table item is used, the stored time field is updated with the current synchronization time at which the MAC address is used;

accordingly, the table item with a minimum time field is a time field which has been stored earliest;

here, the Timeout is a preset Timeout which is generally between 2 and 4 minutes.

Step 306: empty a table item with a minimum time field and set its state field as FREE; empty all of the table items in which time fields have a difference with respect to current time more than a Timeout and set their state fields as FREE.

Step 307: store the searched IP address and update the time field with a current synchronization time;

accordingly, the state field of the table item is set as PENDING.

Step 308: acquire the MAC address corresponding to the IP address and execute Step 303;

acquiring the MAC address corresponding to the IP address specifically includes: broadcast an ARP request message containing a destination IP address on the network layer; accordingly, the IP terminal with that destination IP address returns an ARP response message containing an MAC address corresponding to the destination IP address to the ARP cache; the ARP cache receives this ARP response message, and therefore the ARP cache acquires the MAC address from the ARP response message.

FIG. 4 is a view of the state transition of the ARP cache according to an embodiment of the present disclosure. As shown in FIG. 4, the state of an ARP cache includes: a FREE state 41, a PENDING state 42 and a RESOLVED state 43, in which

the FREE state 41 corresponds to the case of recording of neither IP address nor MAC address;

the PENDING state 42 corresponds to the case of recording of IP address other than MAC address;

the RESOLVED state 43 corresponds to the case of recording of both IP address and MAC address;

when a table item in the FREE state 41 records an IP address, its state turns to the PENDING state 42;

when the table item in the PENDING state 42 records an MAC address, its state turns to the RESOLVED state 43;

when the time field in the table item in the RESOLVED state 43 has a difference with respect to the current time more than Timeout, its state turns to the FREE state 41;

when the time field in the table item in the PENDING state 42 has a difference with respect to the current time more than Timeout, its state turns to the FREE state 41.

The above descriptions are merely the preferred embodiments of the present disclosure, but not to limit the scope of protection of the present disclosure.

1. An Address Resolution Protocol (ARP) cache, comprising a network interface module, a searching module and an ARP cache module;
wherein the network interface module is configured to send an Internet Protocol (IP) data package to the searching module for IP address searching; and to send an acquired Media Access Control (MAC) address corresponding to the IP address to the searching module after the IP address searching fails;
wherein the searching module is configured to search, according to the IP data package sent from the network interface module, the ARP cache module for the IP address corresponding to the IP data package; and to store the IP address and the MAC address sent from the network interface module corresponding to the IP address in the ARP cache module after the IP address searching fails; and
wherein the ARP cache module is configured to provide the IP address to the searching module for the IP address searching; to store the IP address and the MAC address corresponding to the IP address after the IP address searching fails.

2. The ARP cache according to claim 1, wherein the network interface module is further configured to acquire the MAC address corresponding to the IP address after the IP address is stored in the ARP cache module.

3. The ARP cache according to claim 1, wherein the ARP cache module is further configured to: when there is a local table item in an idle state, store the IP address in the table item directly; and when there is no local table item in the idle state, empty a table item with a minimum time field and store the IP address in the table item with the minimum time field.

4. The ARP cache according to claim 1, wherein the network interface module is further configured to receive the IP data package including the MAC address from the ARP cache module after the IP address searching succeeds;
wherein the searching module is further configured to store the received IP data package in the ARP cache module when the IP address searching succeeds; and
wherein the ARP cache module is further configured to, after the searching of the IP succeeds, copy the MAC address according to the IP address into a head of the IP data package and send the IP data package including the MAC address to the network interface module.

5. The ARP cache according to claim 1, wherein the ARP cache module is further configured to store the IP data package after the IP address searching fails.

6. The ARP cache according to claim 1, wherein the ARP cache further comprises a time synchronization module configured to provide the ARP cache module with current synchronized time.

7. The ARP cache according to claim 4, wherein the ARP cache module comprises an IP address storage unit, a MAC address storage unit, a state storage unit, an IP data package storage unit and a time storage unit,
wherein the IP address storage unit is configured to provide the IP address to the searching module for the IP address searching, and to store the IP address after the IP address searching fails;
wherein the MAC address storage unit is configured to store the MAC address corresponding to the IP address, to copy the MAC address into the head of the IP data package and to send the IP data package including the MAC address to the network interface module;
wherein the state storage unit is configured to store the state of the table item;
wherein the IP data package storage unit is configured to store the IP data package; and
wherein the time storage unit is configured to store time at which the IP address is stored, and to update the time with current time when the MAC address is being used.

8. An Address Resolution Protocol (ARP) caching method, comprising:
sending a current IP data package to an APR cache for Internet Protocol (IP) address searching;
after the IP address searching fails, storing the IP address in the ARP cache and storing an acquired Media Access Control (MAC) address corresponding to the IP address in the ARP cache.

9. The ARP caching method according to claim 8, further comprising:
after the IP address is stored in the ARP cache, acquiring the MAC address corresponding to the IP address.

10. The ARP caching method according to claim 8, wherein the storing the IP address in the ARP cache comprises:
when the ARP cache has a table item in an FREE state, storing the IP address in the table item directly; and
when the ARP cache has no table item in the FREE state, emptying a table item with a minimum time field and storing the IP address in the table item with the minimum time field.

11. The ARP caching method according to claim 8, further comprising:
after the IP address searching succeeds, copying the MAC address corresponding to the IP address into a head of the IP data package and sending the IP data package including the MAC address to a destination terminal.

12. The ARP caching method according to claim 9, wherein the acquiring the MAC address corresponding to the IP address comprises:
broadcasting an ARP request message containing an destination IP address on the network layer;
returning, by an IP terminal with the destination IP address, an ARP response message containing the MAC address corresponding to the IP address to the ARP cache; and
receiving, by the ARP cache, the ARP response message and acquiring the MAC address corresponding to the IP address according to the ARP response message.

13. The ARP cache according to claim 2, wherein the network interface module is further configured to receive the IP data package including the MAC address from the ARP cache module after the IP address searching succeeds;
wherein the searching module is further configured to store the received IP data package in the ARP cache module when the IP address searching succeeds; and
wherein the ARP cache module is further configured to, after the searching of the IP succeeds, copy the MAC address according to the IP address into a head of the IP data package and send the IP data package including the MAC address to the network interface module.

14. The ARP cache according to claim 3, wherein the network interface module is further configured to receive the IP data package including the MAC address from the ARP cache module after the IP address searching succeeds;
wherein the searching module is further configured to store the received IP data package in the ARP cache module when the IP address searching succeeds; and
wherein the ARP cache module is further configured to, after the searching of the IP succeeds, copy the MAC address according to the IP address into a head of the IP data package and send the IP data package including the MAC address to the network interface module.

15. The ARP cache according to claim 2, wherein the ARP cache further comprises a time synchronization module configured to provide the ARP cache module with current synchronized time.

16. The ARP cache according to claim 3, wherein the ARP cache further comprises a time synchronization module configured to provide the ARP cache module with current synchronized time.

17. The ARP cache according to claim 5, wherein the ARP cache further comprises a time synchronization module configured to provide the ARP cache module with current synchronized time.
